(19) United States
(12) Patent Application Publication
(10) Pub. No.: US 2022/0292551 A1
(43) Pub. Date: Sep. 15, 2022

(54) SYSTEM AND METHOD FOR SELECTING DONATIONS IN DYNAMIC LIGHTWEIGHT PERSONALIZED ANALYTICS

(71) Applicant: Sandra K. JOHNSON, Cary, NC (US)

(72) Inventor: Sandra K. JOHNSON, Cary, NC (US)

(21) Appl. No.: 17/690,449

(22) Filed: Mar. 9, 2022

Related U.S. Application Data
(60) Provisional application No. 63/161,121, filed on Mar. 15, 2021.

(51) Int. Cl. G06Q 30/02; G06Q 10/06

(52) U.S. Cl. CPC G06Q 30/0279; G06Q 10/06393

(57) ABSTRACT

A system and method for dynamically adjusted charitable donations based on dynamic lightweight personalized analytics (DLPA) is disclosed. The system provides for a remittance analytics engine that determines whether a donation percentage should be increased based on calculations involving historical transfer data, social media, and favorable support from transfer services. The method adjusts donation percentages based on similar analyses and ultimately results in a transfer of funds to a predetermined charity. A differing system and method is used for determining when to transfer a one-time donation under favorable conditions when the increased amount is constant versus determining when to transfer a one-time donation under favorable conditions when the increased amount is variable.

### CROSS REFERENCE TO RELATED APPLICATIONS

This application claims priority to U.S. Provisional Application No. 63/161,121, filed Mar. 15, 2021, the contents of which are incorporated herein in its entirety.

This application relates to U.S. patent application Ser. No. 17/558,838, filed Dec. 22, 2021, which claims priority to U.S. Provisional Application No. 63/129,820, filed Dec. 23, 2020, and U.S. patent application Ser. No. 17/538,182, filed Nov. 30, 2021, which claims priority to U.S. Provisional Application No. 63/119,550, filed Nov. 30, 2020, and U.S. patent application Ser. No. 17/365,080, filed Jul. 1, 2021, which claims priority to U.S. Provisional Application No. 63/047,326, filed Jul. 2, 2020, and U.S. patent application Ser. No. 17/215,750, filed Mar. 29, 2021, which claims priority to U.S. Provisional Application No. 63/000,864, filed Mar. 27, 2020, and U.S. patent application Ser. No. 17/194,746, filed Mar. 8, 2021, which claims priority to U.S. Provisional Application No. 62/986,754, filed Mar. 8, 2020, and U.S. patent application Ser. No. 17/137,677, filed Dec. 30, 2020, which claims priority to U.S. Provisional Application No. 62/922,244, filed Dec. 30, 2019, and U.S. patent application Ser. No. 17/084,778, filed Oct. 30, 2020, which claims priority to U.S. Provisional Application No. 62/927,872, filed Oct. 30, 2019, and U.S. patent application Ser. No. 17/013,895, filed Sep. 8, 2020, which claims priority to U.S. Provisional Application No. 62/897,360, filed Sep. 8, 2019, and U.S. patent application Ser. No. 16/914,629, filed Jun. 29, 2020, which claims priority to U.S. Provisional Application No. 62/868,950, filed Jun. 30, 2019, the contents of which are incorporated herein in their entirety.

### FIELD OF DISCLOSURE

The disclosed embodiments teachings relate generally to determining the minimal set of customer behavior and other relevant information needed to select donation amounts in a relationship-based remittance service. In addition, it focuses on leveraging a small footprint to gain personalized insights used to optimize customer satisfaction based on such donations. Potential participants include not only those in consumer-focused industries and entities, but any entity that benefits from analytics-based suggestions for optimizing relatively small amounts of data for specific actions using fast computational times, along with the social element of associating such actions to charitable donations.

### BACKGROUND

Many consumer-based companies leverage customer behavior data and associated predictive, prescriptive, and other analytic methodologies to gain insights. Such information can translate into suggestions to improve efficiencies, understand trends, optimize customer objectives, create new potential markets, build customer relationships, or discover or prevent fraud, to name a few. There is an abundance of analytics efforts conducted to gain such insights. With an increasingly consumer-centric society, there is a growing focus on behavioral analytics to understand customer preferences that can translate into market gains. Much of this work leverages a plethora of structured and unstructured data, big data, that may be siloed and geographically dispersed for insights.

However, there are many consumer-focused industries that require or benefit from small, lightweight, and fast analytics. For example, the prevailing focus in the remittance industry is the transfer of funds from sender to receiver. The transfer amounts are small, and users require minimal transfer times. With thin industry profit margins, the remittance industry requires all efforts to assist in transferring funds are efficient, lightweight, and fast. In this and many other industries, there are no significant efforts to build customer relationships, understand their preferences, needs and behaviors, and build customer loyalty leveraging small data or lightweight analytics. A study has shown that businesses that develop strong customer connections outperform their competitors by 85% in sales growth and more than 25% in gross margins (“Behavioral Economics,” Gallup, Gallup.com).

Proposed is a system and methodology for suggesting or making transaction-based charitable donations in dynamic lightweight personalized analytics (DLPA). It focuses on when and how to make such donations based on remittance customer behavior, local and global events, geolocation data and other relevant information. Such donations are made to optimize customer satisfaction and other key performance indicators (KPIs) used in quantifying success for remittance services. DLPA is a new innovative technology designed to provide individual analytics to gain insights for developing personalized offerings to build relationships with the customer. DLPA leverages a limited number of customer-specific, industry-focused input parameters, other inputs such as customer behavior, support, and other data, and a small memory footprint. These parameters are placed in data structures to assist in processing DLPA-related actions. This invention focuses on suggesting or making charitable donations, both statically or dynamically, leveraging customer behavior or other events. It is based on customer behavior and other metrics used in DLPA to optimize desirable outcomes. This invention relates to U.S. patent application Ser. Nos. 16/914,629, 17/013,895, 17/084,778, and 17/137,677 and U.S. Provisional Patent Application Nos. 62/986,754, 63/000,864, 63/047,326, 63/119,550 and 63/129,820.

There are some efforts to use analytics in the remittance industry. For example, Remit Radar's Galileo (https://remitradar.com/Home/Galileo) uses analytics to understand global remittance market trends. Lexis Nexis (http://threatmetrixx.com) and others use analytics to discover glitches or behavior anomalies and detect and prevent fraud. Most focus on overall trends and patterns, not individual behaviors, to gain insights for unique customer offerings. To our knowledge, there are no efforts to develop dynamic lightweight personalized analytics methodologies to gain insights for customized services real time. This would be a significant game-changer, for example, in the $550B+ global cross-border remittance industry.

### SUMMARY

Embodiments of the present disclosure provide a system for selecting donations in dynamic lightweight personalized analytics (DLPA). The system having an interface that receives one or more inputs via an enterprise payment services bus; a data storage unit comprising a customer account database and a trends database, wherein the customer account database is further configured to store at least account profiles, support data, DLPA metrics, and key performance indicators (KPIs); and a remittance analytics engine comprising a computer processor and coupled to the data storage unit and the interface, the computer processor configured to determine when to transfer a one-time donation under favorable conditions when the increased amount is constant. The determination comprising the following steps: first, the processor sets a collection of metrics to their default values, the metrics comprising: the default trigger for the number of transfers (d_#_xfers) and the default cumulative transfer amount trigger (d_xfer_amt). Next, the processor compares the metrics for a predetermined time window. Next, the processor calculates a new set of parameters for the donation metrics and KPIs. Next, the processor determines whether to increase the donation percentage (d-incr) by a predetermined amount upon any one of the following being true: (1) the number of remittance transfers (# xfers) is greater than or equal to the default trigger (d_#_xfers), (2) the cumulative transfer amount for the customer (cum_xfer) is greater than or equal to the default cumulative transfer amount trigger (d_xfer_amt), (3) if one or more favorable social media actions (fav_sm) has occurred, and (4) if the customer experiences one or more instances of favorable support from a transfer service (fav_sup). Then, the processor transfers, upon a determination to increase the donation percentage, the donation to a predetermined charity. Then the processor executes, upon a determination that none of the events are true, the comparison in a different time window.

Embodiments of the present disclosure also provide a method for determining when to transfer a one-time donation under favorable conditions when the increased amount is constant, the method comprising the following steps: First, the method begins with adjusting a collection of metrics to their default values, the metrics comprising: the default trigger for the number of transfers (d_#_xfers) and the default cumulative transfer amount trigger (d_xfer_amt). Then, comparing, by the processor, the metrics for a predetermined time window (dTW) and calculating a new set of parameters for the donation metrics and KPIs. Then, the processor determines whether to increase the donation percentage (d_incr) by a predetermined amount upon any one of the following being true: (1) the number of remittance transfers (# xfers) is greater than or equal to the default trigger (d_#_xfers), (2) the cumulative transfer amount for the customer (cum_xfer) is greater than or equal to the default cumulative transfer amount trigger (d_xfer_amt), (3) if one or more favorable social media actions (fav_sm) has occurred, and (4) if the customer experiences one or more instances of favorable support from a transfer service (fav_sup). Then, the method continues with transferring, upon a determination to increase the donation percentage, the donation to a predetermined charity. Then, the processor executes, upon a determination that none of the events are true, the comparison in a different time window.

Embodiments of the present disclosure also provide a system for selecting donations in dynamic lightweight personalized analytics (DLPA). The system having an interface that receives one or more inputs via an enterprise payment services bus; a data storage unit comprising a customer account database and a trends database, wherein the customer account database is further configured to store at least account profiles, support data, DLPA metrics, and key performance indicators (KPIs); and a remittance analytics engine comprising a computer processor and coupled to the data storage unit and the interface, the computer processor configured to determine when to transfer a one-time donation under favorable conditions when the increased amount is variable. The determination comprises the following steps. First, comparing, by the processor, the metrics for a predetermined time window. Next, the processor calculates a new set of parameters for the donation metrics and KPIs. Next, the processor determines whether to adjust the donation percentage by a predetermined amount upon any one of the following conditions being true: (1) the number of remittance transfers (# xfers) is greater than or equal to the trigger number (num_trig), (2) the cumulative transfer amount (cum_xfer) is greater than or equal to the trigger cumulative amount (amt_trig), (3) the number of favorable social media events is greater than or equal to the trigger number for favorable social media events (sm_trig), (4) the number of favorable support events (fav_sup) is greater than or equal to the trigger for the number of favorable support events (sup_trig), (5) the number of key customer milestones (kms) is greater than or equal to the trigger number for key customer milestones (ms trig). Next, the processor calculates, upon determining that any one of the conditions are true, whether current donation percentage increase (d_incr) is less than or equal to the maximum possible donation percentage (max_%). Next, the processor increments, upon calculating that d_incr is greater than max_%, the d_incr value by the amount incr dn. Next, the processor increases, upon incrementing the d_incr value, the percentage of the funds transfer fee by the incremented d_incr value. Next, the processor transfers the d_incr value of the funds to a predetermined charity. Next, the process compares the metrics for a new predetermined time window.

Embodiments of the present disclosure also provide a method for selecting donations in dynamic lightweight personalized analytics (DLPA). The method including the following: comparing, by the processor, the metrics for a predetermined time window; calculating a new set of parameters for the donation metrics and KPIs; determining whether to adjust the donation percentage by a predetermined amount upon any one of the following conditions being true: (1) the number of remittance transfers (# xfers) is greater than or equal to the trigger number (num_trig), (2) the cumulative transfer amount (cum_xfer) is greater than or equal to the trigger cumulative amount (amt_trig), (3) the number of favorable social media events is greater than or equal to the trigger number for favorable social media events (sm_trig), (4) the number of favorable support events (fav_sup) is greater than or equal to the trigger for the number of favorable support events (sup_trig), (5) the number of key customer milestones (kms) is greater than or equal to the trigger number for key customer milestones (ms_trig). Next, the method continues with calculating, upon determining that any one of the conditions are true, whether current donation percentage increase (d_incr) is less than or equal to the maximum possible donation percentage (max_%); incrementing, upon calculating that d_incr is greater than max_%, the d_incr value by the amount incr dn; increasing, upon incrementing the d_incr value, the percentage of the funds transfer fee by the incremented d_incr value; transferring the d_incr value of the funds to a predetermined charity; and comparing, by the processor, the metrics for a new predetermined time window.

### BRIEF DESCRIPTION OF THE DRAWINGS

FIG. 1 is a block diagram of a remittance payments service-oriented architecture in accordance with exemplary embodiments of the disclosure.

FIG. 2 is a block diagram of a remittance data storage in accordance with exemplary embodiments of the disclosure.

FIG. 3 is a block diagram of the types of data stored in a remittance data storage in accordance with exemplary embodiments of the disclosure.

FIG. 4 is a block diagram of the partial contents of a remittance data store in accordance with exemplary embodiments of the disclosure.

FIG. 5 is a block diagram of the dynamic lightweight personalized analytics (DLPA) engine, including donation suggestions, in accordance with exemplary embodiments of the disclosure.

FIG. 6 is a flowchart illustrating an exemplary method for determining when to transfer a one-time donation under favorable conditions when the increased donation amount is constant.

FIG. 7 is a flowchart illustrating an exemplary method for determining when to transfer a one-time donation under favorable conditions when the increased donation amount is variable.

FIG. 8 is a flowchart illustrating an exemplary method for resetting default metrics once maximum values are reached.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labelled as modules, to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

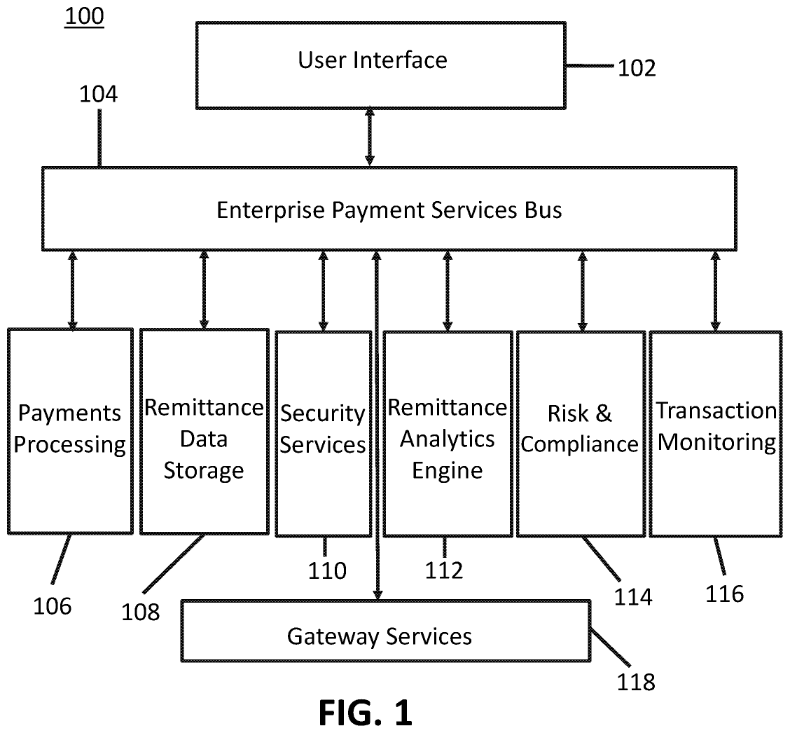

FIG. 1 is a schematic block diagram illustrating one embodiment of the service-oriented architecture (SOA) 100 of a remittance system designed to process transactions, in accordance with one embodiment of the present invention. The system 100, in one embodiment, includes a user interface 102 that enables a user to send or receive requests and other messages. This user interface 102 interacts with the enterprise payments services bus 104 to request or receive services. The enterprise payments services bus 104 may be configured to transmit data between engines, databases, memories, and other components of the system 100 for use in performing the functions discussed herein.

The enterprise payments services bus 104 may be comprised of one or more communication types and utilize various communication methods for communications within a computing device. For example, the enterprise payments services bus 104 may be comprised of a bus, contact pin connectors, wires, etc. In some embodiments, the enterprise payments services bus 104 may also be configured to communicate between internal components of system 100 and external components accessible through gateway services 118, such as externally connected databases, display devices, input devices, and other related devices.

There are several services that may compose this SOA 100, including payments processing 106, remittance data storage 108, security services 110, the remittance analytics engine 112, risk and compliance 114, transaction monitoring 116, and gateway services 118, which are described below. Each of these service components may be software, a computer-readable program, executing on one of more processors, and may include a mainframe computer, a workstation, a desktop computer, a computer in a smart phone, a computer system in a rack, a computer system in a cloud, a physical system, a virtual system, and the like.

The system 100, in one embodiment, is the SOA of a remittance system and is a network of software service components in which the illustrative embodiments may be implemented. The system 100 includes a user interface 102 used by a consumer. The consumer represents a person, a software program, a virtual program, or any other entity that has possession of, can emulate, or other otherwise issue commands to execute transactions in the system 100. The system 100 includes an enterprise payment services bus 104 which accepts and processes commands from the user interface 102 and other system components. It also enables communication among the various services components in the system 100.

As a part of executing a remittance request, the transaction may leverage payments processing 106 to process the request. Such processing may also include the creation and funding of financial accounts associated with a recipient. The transaction may also access remittance data storage 108 which is a resource for data access. Security services 110 are also leveraged to ensure the full security and integrity of funds and data, and to detect and prevent fraud. In addition, the remittance analytics engine 112 is leveraged and is the foundation for DLPA. This engine takes as input a plethora of information from the remittance data storage 108 and other components that may enable the remittance analytics engine 112 to optimize its outputs. The risk and compliance 114 service provide customer identification, verification and other similar services required to comply with relevant governmental regulations and to minimize risk. The transaction monitoring 116 service tracks funds transfer behavior and other activities to detect anomalies that may point to fraud. It works in concert with security services 110.

Gateway services 118 enable the transfer of funds, data, requests, etc. to externally connected entities for further processing. Such entities may include a computer network, a financial institution, and others that may participate in end-to-end remittance or other funds transfer or data services. Other similar embodiments will be apparent to persons having skill in the relevant art.

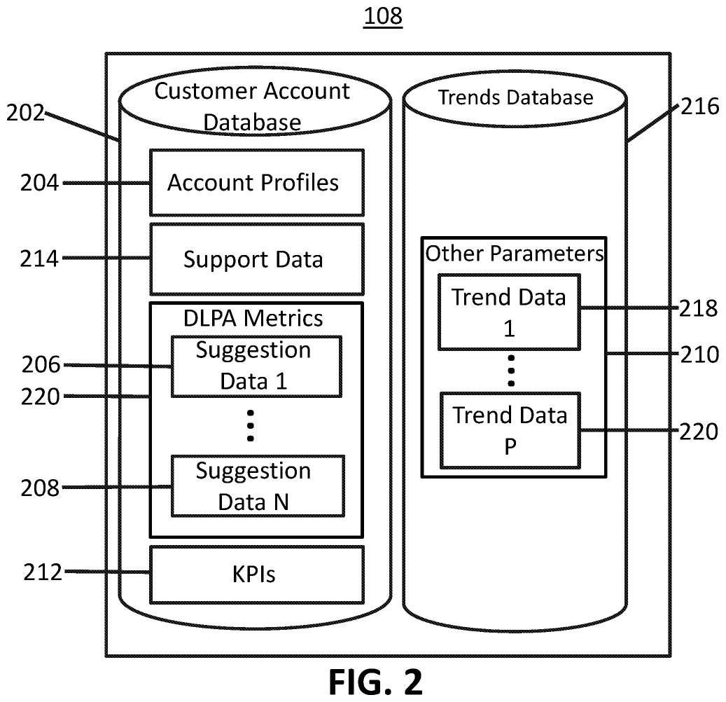

FIG. 2 is a schematic block diagram illustrating one embodiment of the remittance data storage service 108 used in the processing of information requests. The remittance data storage 108 may be a relational database, or a collection of relational databases, that utilizes structured query language for the storage, identification, modifying, updating, accessing, etc. of structured data sets stored therein. This data storage 108 is composed of a customer account database 202 that contains customer account and other related customer information. The customer account database 202 may be configured to store a plurality of consumer account profiles 204 as well as a plurality of DLPA metrics 220, including suggestions to customers 206 and 208, using a suitable data storage format and schema. The customer account database 202 also contains support data 214 and key performance indicators (KPIs) 212. Please see a larger list of potential DLPA metrics in the Glossary of Terms. In addition, those skilled in the relevant art will understand this is a representative embodiment. There are other similar metrics that may be used in other embodiments.

Each customer account profile 204 may be a structured data set configured to store data related to a remittance account. Each customer account profile 204 may include at least the customer's full name, address, telephone number, birthdate, birth country, a remittance account number, a bank account number, credit card account information, email address, a list of recipients and associated international mobile telephone numbers, remittance transaction history, a postal mailing address, an email address, and other relevant information. The customer account profile 204 may also include additional information suitable for customer service programs, customer and vendor optimizations, and regulations, such as product data, offer data, loyalty data, reward data, usage data, currency-exchange data, mobile money data, fraud scoring, validity of funds, and transaction/account controls. The customer account profile 204 may also include additional information that may be required for know-your-customer (KYC) and anti-money laundering (AML) regulations. It may further contain information suitable for performing the functions discussed herein, such as communication details for transmitting via the enterprise payment services bus 104.

The suggestion data 206 and 208 can include various types of suggestions or recommendations made to the customer and used to quantify success. Such suggestions are included in the Rec-Array with a maximum number of entries or Rec-Array-Max. Examples of suggestion data can include the recommendation acceptance rate (RAR), recommendation impact (RI), recommendation acceptance impact (RAI), financial account acceptance rate (FAR), financial recommendation impact (FRI), financial recommendation acceptance impact (FAI), other recommendation rate (OAR), other recommendation impact (ORI), other recommendation acceptance impact (ORI), or some other charitable donations suggestions. Please see a larger list of potential DLPA metrics in the Glossary of Terms. In addition, those skilled in the art will understand this is a representative embodiment. There are other similar metrics that may be used in other embodiments.

Examples of support data 214 stored include the type of support inquiry, how it was resolved, response time, resolution time, frequency of support contact, customer satisfaction data and other similar metrics. Example KPIs 212 are listed in the Glossary of Terms. Some include the total funds transferred per customer, the total number of transfers per customer, the total number of recipients per customer, and the total balances in all financial accounts per customer.

Also contained in the remittance data storage 108 is a trends database 216, which includes other parameters 210, including trend data 218 and 220. Examples of other parameters 210 include the LG-Mix, transaction data, customer temperament information, external events, social media data, geolocation data, communications data, recipient data, and milestone events. This data also includes OP-Max, the maximum number of other parameters 210 considered per customer, and OP-Count-Trigger, used to determine when to remove or replace other parameters 210. OP-Max also represents the size of the other parameter 210 array per customer. Both OP-Max and OP-Count-Trigger are default parameters that may be adjusted dynamically.

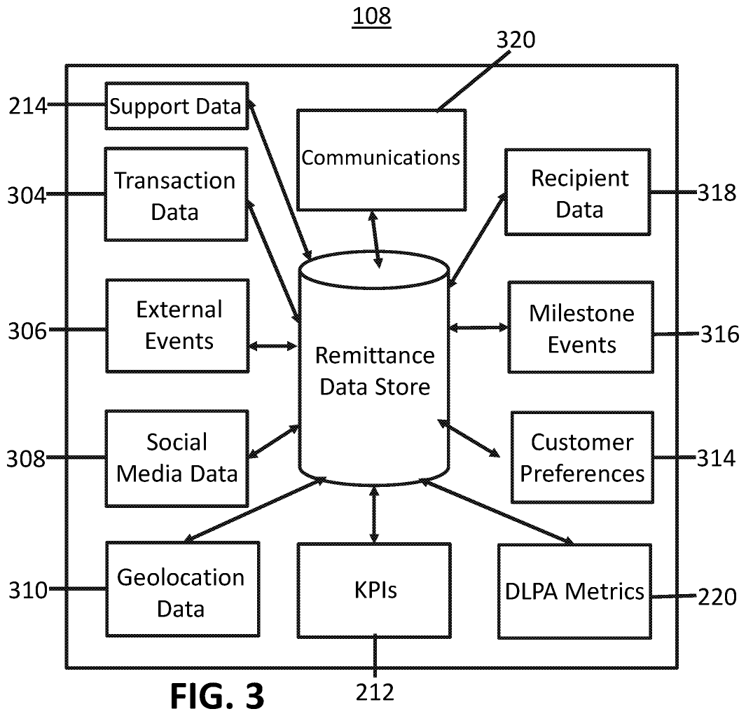

FIG. 3 is a schematic block diagram illustrating one embodiment of specifics regarding the plurality of data that may be stored in the remittance data storage 108. This data may be stored as structured data sets that may include support data 214, transaction data 304, external events data 306, social media data 308, geolocation data 310, KPIs 212, DLPA metrics 220, customer preferences 314, milestone events 316, recipient data 318, and communications data 320.

Example transaction data 304 may include the transfer amount, transfer time, recipient name and international mobile number, the time since the last transfer initiated by the sender to any receiver, the time since the last transfer initiated by the sender to a specific receiver, and the final status of a transaction (e.g., completed or completed). Additional data may include metrics to quantify customer sentiments such as the number of times or frequency that the customer contacted support, time with support, and support outcomes. Example external events 306 include general remittance transaction data such as transfer amounts and frequency for other customers using the specific remittance service or for remittance customers using any remittance service, public holidays for the sender and receiver countries, natural disasters, immigration policies, the price of oil, global and local recessions.

Example social media data 308 may include posts and other exchanges in Facebook, Twitter, Instagram, LinkedIn, and other similar social media platforms. Example geolocation data 310 may include the physical location of the sender and receiver when the funds transfer is initiated or received, and it can also include the physical location of the sender or receiver at specific or random times. Other similar embodiments will be apparent to persons having skill in the relevant art.

Example customer preferences 314 are from the perspective of the sender. They may include hobbies, favorite things to do, and financial preferences. Furthermore, DLPA enables the creation of a financial or other count by the customer to save for the future. This account may be created and funded either statically or dynamically. A customer preference 314 may include the customer's desire to create a separate account (or some other activity) based on DLPA analytics, to choose the type of account, and to determine how to fund the account.

A customer preference 314 may be to create a financial or other account when registering for the remittance service, or upon DLPA recommendations when using the remittance service. Such an account may be targeted for the customer's remittance recipients. A customer may select between a check, savings, money market, brokerage, or other similar account. The customer may choose the purpose for creating a bank account (e.g., for education, starting a business, donating to a charity or some other option for the sender and/or the receiver). The choices may be general (e.g., the same type of account for sender and each recipient), for each recipient, or variable (e.g., a different type of account depending on the recipient or a group of recipients). Other similar embodiments will be apparent to persons having skill in the relevant art.

Example milestone events 316 may include birthdays, including milestone birthdays (e.g., 18, 25, 30, etc.), weddings, anniversaries, graduations, and other special days for the sender or receiver. Example recipient data 318 may include full name, international telephone number, and recipient preferences that are like customer preferences 314. Communications data 320 may include the recent types of communications between sender, receiver, the remittance service provider, and external entities. This includes SMS messages, email, and communication types. Other similar embodiments will be apparent to persons having skill in the relevant art.

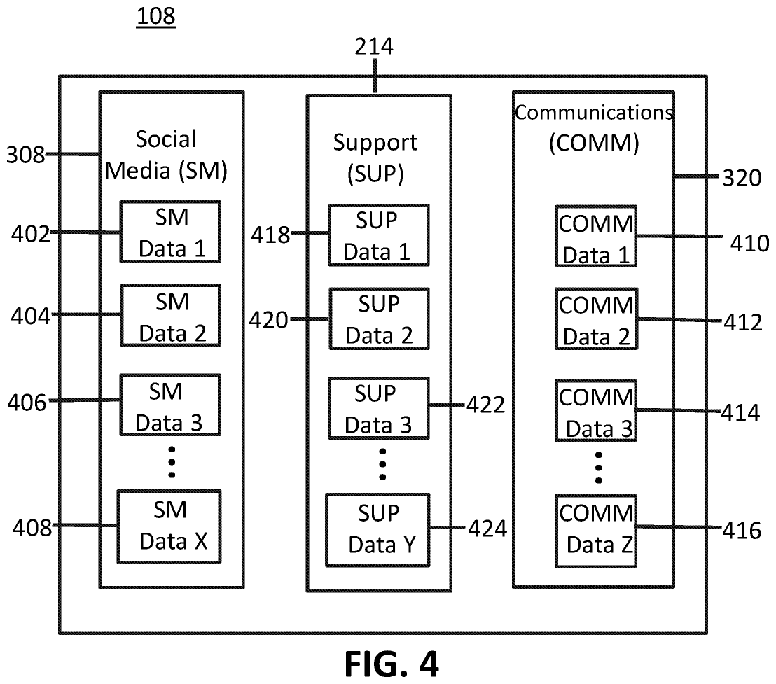

FIG. 4 is a schematic block diagram illustrating one embodiment of partial contents of the remittance data storage 108. It contains a plurality of social media data 308: 402, 404, 406, and 408; support data 214: 418, 420, 422, and 424; and communications data 320: 410, 412, 414, and 416. Associated with each of these types of data is its associated impact, the social media impact, support impact and communication impact. These metrics are also stored in the remittance data storage 108, but not presented in FIG. 4. Each impact metric is calculated as the fraction of favorable outcomes for social media, support, and communications, respectively, resulting in an increase in at least one KPI in the customer's KPI-Array.

The plurality of social media 308, support 214, and communications data 320 is stored in relevant arrays of size X, Y and Z, respectively. The size of these arrays can vary as detailed in U.S. patent application Ser. No. 17/084,778.

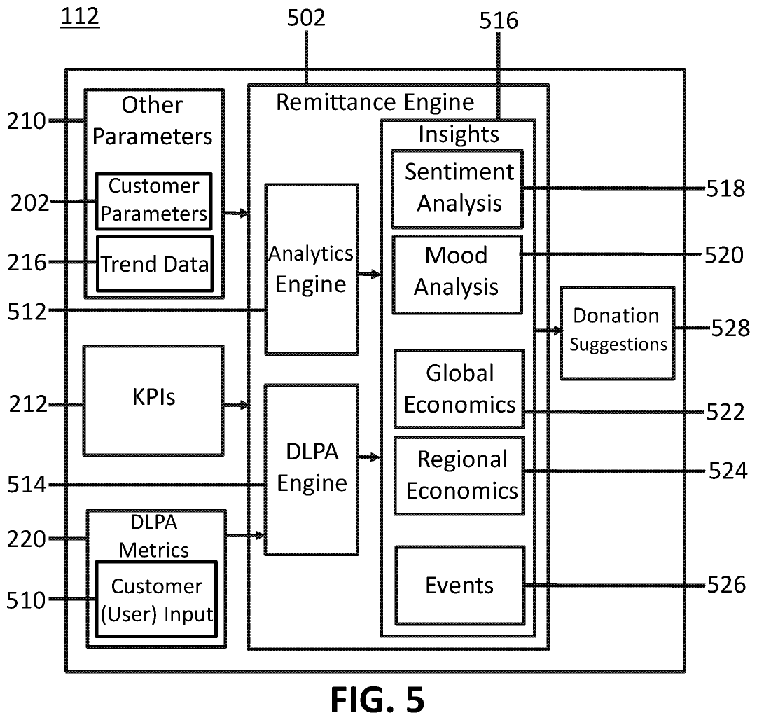

FIG. 5 is a schematic block diagram illustrating one embodiment of the remittance analytics engine 112, the foundation for DLPA. It includes at its core the remittance engine 502, which contains the analytics engine 512, and the DLPA engine 514. The remittance engine 502 accepts customer parameters 202 and remittance trends 216 as input. Customer parameters 202 consist of social media 308, support data 214, and communications 320 as well as other data. They collectively form the other parameters 210 set of inputs. Other input metrics include the KPIs 212. The DLPA engine 514 processes DLPA-related events. It accepts DLPA metrics 220. These metrics 220 are impacted by donation suggestions 528. Such information is contained in the customer input data 510, a component of the DLPA metrics 220. Outputs from the analytics engine 512 and DLPA engine 514 are leveraged to provide insights 516 for sentiment analysis 518, mood analysis 520, global 522 and regional 524 economics, and events 526. Such insights 516 are then used to make donation suggestions 528 and other similar suggestions.

The remittance engine 502 is the primary computational engine for leveraging predictive, customer behavioral and other analytics techniques for optimal donation suggestions 528 for DLPA. It further utilizes a plurality of customer parameters 202, including social media 308, support 214, and communications data 320, remittance trends 216, KPIs 212 and DLPA metrics 220 as input for its calculations.

Donation suggestions 528 may include a suggestion for making a special donation, d_incr, to a nonprofit organization based on certain favorable conditions such as great support, fav_sup, or social medial postings, fav_sm, regarding the remittance service, or achieving a key customer milestone, kms 316. The suggestions may be associated with the frequency of achieving such metrics within a given time window, dTW, or a few time windows, #TWs.

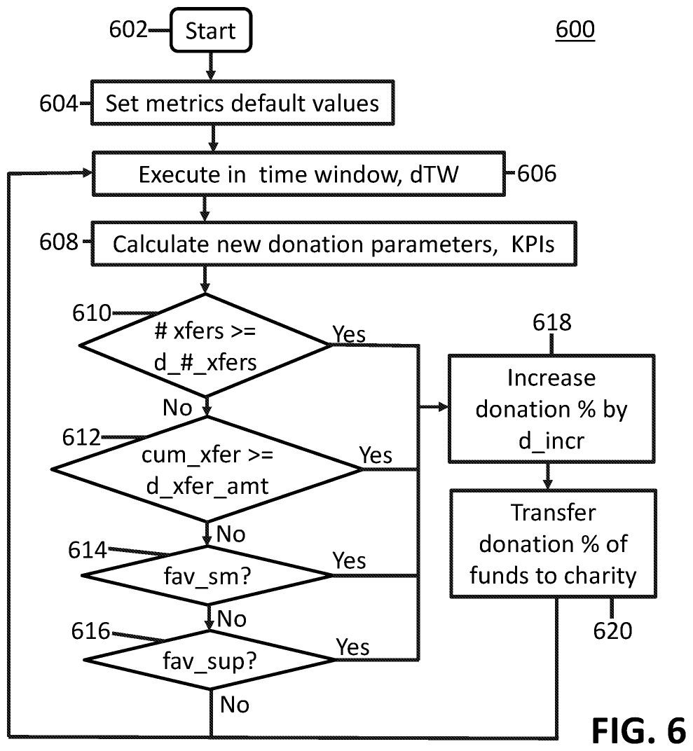

FIG. 6 is a flowchart illustrating an exemplary method for determining when to transfer a one-time donation under favorable conditions when the increased amount is constant. The service method starts 602 by setting the relevant metrics to their default values 604. Next, the method executes for a given time window, dTW 606. Then, the new donation parameters and KPIs are calculated 608. Next, the number of remittance transfers are compared to the default trigger for the number of transfers. If this number is greater than or equal to the default trigger 610, then the percentage of the transfer fee used to calculate a donation is increased by the amount, d_incr 618, and a donation, based on this new percentage, is transferred to the charity 620.

If the answer is no to the number of transfers question 610, then the cumulative transfer amount for the customer is compared to the default cumulative transfer amount trigger, d_xfer_amt. If this number is greater than or equal to the default cumulative amount 612, then the donation percentage is increased by d_incr 618, and donation funds are transferred to a charity 620. Otherwise, if a favorable social media post has occurred 614 (or a given number of favorable social media posts), the new donation percentage is calculated 618 and a donation is transferred to the charity based on this new percentage 620. Likewise, if the customer experiences favorable support from the transfer service 616 (or a certain number of favorable support experiences), then a new donation percentage is calculated 618, and a donation is transferred to a charity based on this new percentage 620. If none of these events, 610, 612, 614, and 616, occur, then the method executes in another time window, dTW 606.

The exemplary method described assumes a wholistic cumulative transfer amount and its associated trigger. However, another exemplary method may consider the cumulative transfer amounts, and the triggers to a given recipient. Thus, there may be an array of transfer amounts, one for each recipient receiving funds per sender. Similar arrays may also be considered for all metrics presented and others not included in this exemplary method.

In addition, other methods not included in this exemplary method, may also be considered, as determined by those skilled in the relevant art. For example, one may also consider the number of key customer milestones achieved, kms 316, as a basis for sending a specific donation to a charity. On the other hand, not all these metrics may be considered. Other embodiments may consider a subset of these embodiments. In addition, the metrics presented and discussed may be a subset of a superset of metrics, as determined by those skilled in the relevant art.

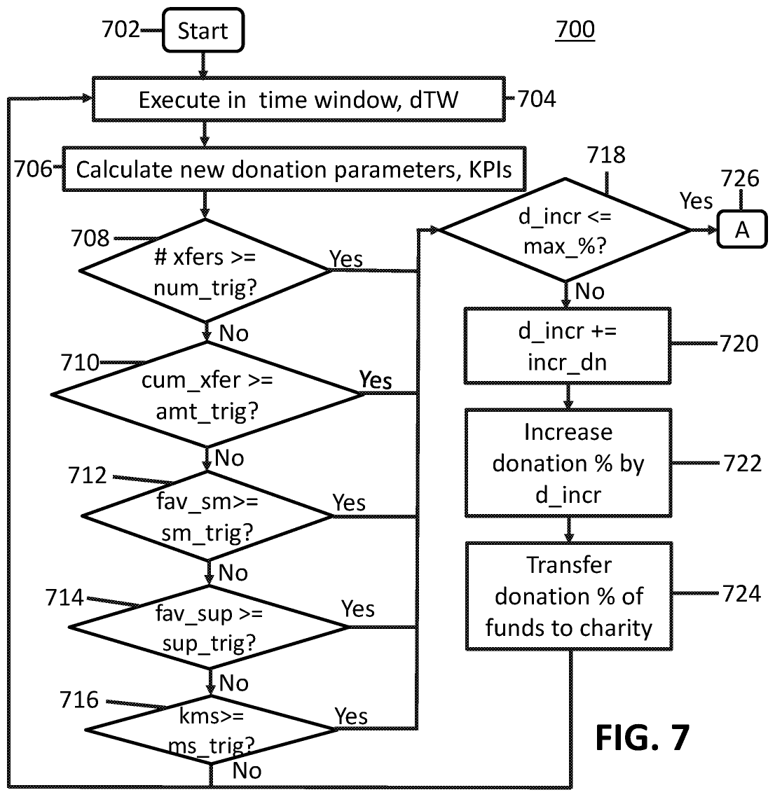

FIG. 7 is a flowchart illustrating an exemplary method for determining when to transfer a one-time donation under favorable conditions when the increased amount is variable. The service method starts 702 by executing for a given time window, dTW 704. Then, the new donation parameters and KPIs are calculated 706. Next, the number of remittance transfers are compared to the trigger for the number of transfers required to increase the donation percentage. If this number is greater than or equal to the trigger number, num_trig 708, then the donation percentage of the transfer fee is dynamically adjusted. Otherwise, the method moves on to the next step.

If the cumulative transfer amount is greater than or equal to the trigger cumulative amount for dynamic donation percentage adjustment 710, then the donation percentage is dynamically adjusted. If not, then if a favorable social media event has occurred (or several such events have occurred) and the number is greater than or equal to the trigger for the number of favorable social media events needed to dynamically adjust the donation percentage, sm_trig 712, then the donation percentage is dynamically adjusted. If not, then likewise, if a favorable support event has occurred (or a few such events have occurred) and the number is greater than or equal to the trigger for the number of favorable support events needed to dynamically adjust the donation percentage, sup_trig 714, then the donation fee is dynamically adjusted. In not, then if the number of key customer milestones, kms 316, is greater than or equal to the trigger for the number of such milestones to occur before triggering a dynamic adjustment in the donation percentage 716, then the donation transfer percentage is dynamically adjusted. Otherwise, the method executes in the time window, dTW 704.

The exemplary method described assumes a wholistic cumulative transfer amount and its associated trigger. However, another exemplary method may consider the cumulative transfer amounts and the triggers to a given recipient. Thus, there may be an array of transfer amounts, one for each recipient receiving funds per sender. Similar arrays may also be considered for all metrics presented, and others not included in this exemplary method.

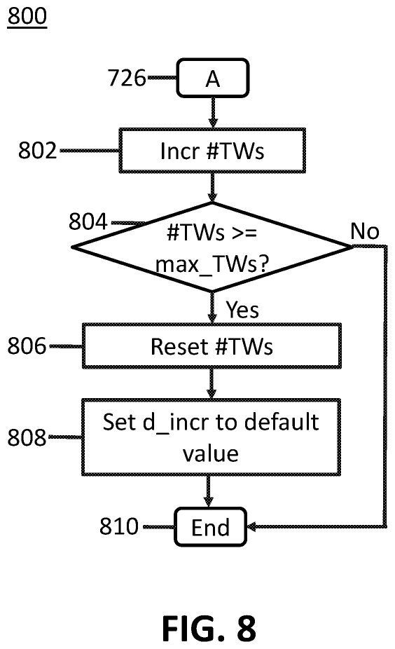

The donation percentage is dynamically adjusted by first determining if the current donation percentage increase, d_incr, is less than or equal to the maximum possible donation percentage, max_% 718. If yes, then adjustments are made to the metrics 726 (see FIG. 8). Otherwise, the amount of donation percentage increase, d_incr is incremented by the amount incr_dn (which may be a default, constant value or dynamically determined) 720. Next, the percentage of the funds transfer fee allocated to a donation is increased by the newly calculated d_incr 722, and the donation is transferred to the charity 724. Afterwards, the method executes in the time window, dTW 704.

Not all these metrics may be considered. Other embodiments may consider a subset of these embodiments. In addition, the metrics presented and discussed may be a subset of a superset of metrics, as determined by those skilled in the relevant art.

FIG. 8 is a flowchart illustrating an exemplary method for resetting default metrics once maximum values are reached. It begins 726 by incrementing the number of time windows, #TWs 802. If this number is greater than or equal to the maximum number of time windows, max TWs 804, then the number of time windows, #TWs is reset to its default 806, the value for the default for incrementing the donation percentage, d_incr, is set to its default 808, and the method ends 810.

The embodiments described herein assumes the donation percentages are a percentage of the next transfer amount from the customer to a one or more recipients. Thus, a portion of the transfer amount goes to the recipient, and a portion goes to the charitable organization. Another embodiment is to enable the transfer amount to be calculated as a percentage of the transfer amount. However, the actual funds are transferred from a special and separate financial account associated with and controlled by the customer, and not from the funds transferred to the recipient. In such embodiments, the customer decides the source of the funds. This may be included in the list of customer preferences 314.

### Glossary of Terms

Algorithm: a set of steps or rules that enables the solution to an issue.
Analytics: a methodology for discovering, understanding, and communicating meaningful patterns in data.
Architecture: the fundamental structures of a system and the associated discipline for creating such structures.
Communications Data: information deriving from the customer's communications, include SMS messages and email.
DLPA Metrics: parameters used in DLPA methodology.
FAR: financial account acceptance rate; the fraction of all financial account recommendations per customer accepted.
FRI: financial recommendation impact; fraction of all financial account recommendations resulting in an increase in at least one KPI in KPI-Array.
FAI: finance recommendation acceptance impact; fraction of all accepted financial account recommendations resulting in an increase in at least one KPI in KPI-Array.
CIS: Change in Savings, the change in the total savings amounts per customer, or per recipient per customer, between time windows.
Donation Trigger Parameters:
   d_incr: default increase in donation percentage.
   incr_dn: donation percentage increases by this amount.
   d_#_xfers: default trigger for the number of transfers.
   d_xfer_amt: default cumulative transfer amount trigger.
   kms: the number of key customer milestones achieved.
   fav_sm: favorable social media, may be a number.
   fav_sup: favorable support, may be a number.
   num_trig: number of transfers that trigger an increase in donation percentage.
   amt_trig: cumulative amount trigger for increasing donation percentage.
   sm_trig: the trigger for the number of favorable social media posts leading to donation percentage increase.
   sup_trig: the trigger for the number of favorable support engagements leading to a donation percentage increase.
   ms_trig: the trigger for the number of key customer milestones reached, leading to a donation percentage increase.
   max_%: maximum percentage of the funds transfer fee for donations.
Key Performance Indicators (KPIs):
   TFT: Total funds transferred per customer (sender).
   TFT-Min: the minimum value for TFT.
   TNT: Total number of transfers per customer.
   TB: Total balances in all financial accounts per customer.
   TB-Min: the minimum value for TB.
   NR: Total number of recipients per customer.
   NFA: Total number of financial accounts per customer.
   KPI-Array: a collection the KPIs of focus per customer.
   KPI-Max: the maximum number of KPIs considered per customer.
   KPI-Count-Trigger: used to determine when to remove or replace a KPI.
   LG-Mix: a fraction of all DLPA suggestions (local and global) that are local.
Other Parameters: DLPA parameter and trend data, described in U.S. patent application Ser. No. 16/914,629. Examples include the LG-Mix, transaction data, external events, social media data, geolocation data, communications data, recipient data, milestone events, trend data, etc.
dTW: default time window, the given time frame for calculating parameters, making decisions.
#TW: number of time windows.
max_TWs: trigger for maximum number of time windows before a reset.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

1. A system for selecting donations in dynamic lightweight personalized analytics (DLPA), the system comprising:
an interface that receives one or more inputs via an enterprise payment services bus;
a data storage unit comprising a customer account database and a trends database, wherein the customer account database is further configured to store at least account profiles, support data, DLPA metrics, and key performance indicators (KPIs); and
a remittance analytics engine comprising a computer processor and coupled to the data storage unit and the interface, the computer processor configured to determine when to transfer a one-time donation under favorable conditions when the increased amount is constant, the determination comprising:
adjusting a collection of metrics to default values, the metrics comprising: a default trigger for the number of transfers (d_#_xfers) and a default cumulative transfer amount trigger (d_xfer_amt);
comparing, by the processor, the metrics for a predetermined time window (dTW);
calculating a new set of parameters for the metrics and KPIs,
determining whether to increase a donation percentage (d_incr) by a predetermined amount upon any one of the following being true: (1) the number of remittance transfers (# xfers) is greater than or equal to the default trigger (d_#_xfers), (2) a cumulative transfer amount for the customer (cum_xfer) is greater than or equal to the default cumulative transfer amount trigger (d_xfer_amt), (3) upon one or more favorable social media actions (fav_sm) occurring, and (4) upon the customer experiencing one or more instances of favorable support from a transfer service (fav_sup);
transferring, upon a determination to increase the donation percentage, the donation to a predetermined charity;
executing, upon a determination that none of the events are true, the comparison in a different time window.

2. The system of claim 1, wherein the d_#_xfers is the default trigger for the number of transfers recognized by the analytics engine in a given time window and the d_xfer_amt is default cumulative transfer amount trigger set by the analytics engine in a given time window.

3. The system of claim 1, wherein the fav_sm is a favorable social media action comprising one or more social media posts, social media trends, or one or more reactions to one or more social media posts, and fav_sup is a favorable support comprising one or more responses from one or more donation transfer services.

4. The system of claim 1, wherein the d_incr is a default increase in donation percentage set by the processor.

5. A method for determining when to transfer a one-time donation under favorable conditions when the increased amount is constant, the method comprising:
adjusting a collection of metrics to default values, the metrics comprising: a default trigger for the number of transfers (d_#_xfers) and a default cumulative transfer amount trigger (d_xfer_amt);
comparing, by the processor, the metrics for a predetermined time window (dTW);
calculating a new set of parameters for the metrics and KPIs,
determining whether to increase the donation percentage (d_incr) by a predetermined amount upon any one of the following being true: (1) a number of remittance transfers (# xfers) is greater than or equal to the default trigger (d_#_xfers), (2) a cumulative transfer amount for the customer (cum_xfer) is greater than or equal to the default cumulative transfer amount trigger (d_xfer_amt), (3) upon one or more favorable social media actions (fav_sm) occurring, and (4) upon the customer experiencing one or more instances of favorable support from a transfer service (fav_sup);
transferring, upon a determination to increase the donation percentage, the donation to a predetermined charity;
executing, upon a determination that none of the events are true, the comparison in a different time window.

6. The method of claim 5, wherein the d_#_xfers is the default trigger for the number of transfers recognized by the analytics engine in a given time window and the d_xfer_amt is default cumulative transfer amount trigger set by the analytics engine in a given time window.

7. The method of claim 5, wherein the fav_sm is a favorable social media action comprising one or more social media posts, social media trends, or one or more reactions to one or more social media posts and fav_sup is a favorable support comprising one or more responses from one or more donation transfer services.

8. The method of claim 5, wherein the d_incr is a default increase in donation percentage set by the processor.

9. A system for selecting donations in dynamic lightweight personalized analytics (DLPA), the system comprising:
an interface that receives one or more inputs via an enterprise payment services bus;
a data storage unit comprising a customer account database and a trends database;
wherein the customer account database is further configured to store at least account profiles, support data, DLPA metrics, and key performance indicators (KPIs); and
a remittance analytics engine comprising a computer processor and coupled to the data storage unit and the interface, the computer processor configured to determine when to transfer a one-time donation under favorable conditions when the increased amount is variable, the determination comprising:
comparing, by the processor, a set of metrics for a predetermined time window, the metrics comprising: a number of remittance transfers (# xfers), a cumulative transfer amount (cum_xfer), a number of favorable social media events (fav_sm), a number of favorable support events (fav_sup), and a number of key customer milestones (kms);
calculating a new set of parameters for the metrics and KPIs;
determining whether to adjust a donation percentage by a predetermined amount upon any one of the following conditions being true: (1) the number of remittance transfers (# xfers) is greater than or equal to the trigger number (num_trig), (2) the cumulative transfer amount (cum_xfer) is greater than or equal to the trigger cumulative amount (amt_trig), (3) the number of favorable social media events (fav_sm) is greater than or equal to a trigger number for favorable social media events (sm_trig), (4) the number of favorable support events (fav_sup) is greater than or equal to a trigger for the number of favorable support events (sup_trig), and (5) the number of key customer milestones (kms) is greater than or equal to a trigger number for key customer milestones (ms_trig);
calculating, upon determining that any one of the conditions are true, whether current donation percentage increase (d_incr) is less than or equal to the maximum possible donation percentage (max_%);
incrementing, upon calculating that the donation percentage increase (d_incr) is greater than max_%, the d_incr value by the amount (incr_dn);
increasing, upon incrementing the donation percentage increase (d_incr) value, the percentage of the funds transfer fee by the incremented d_incr value;
transferring the donation percentage increase (d_incr) value of the funds to a predetermined charity; and
comparing, by the processor, the metrics for a new predetermined time window.

10. The system of claim 9, wherein the processor is further configured to:
adjust, upon determining that d_incr is less than or equal to max_%, the number of time windows (#TWs);
determine whether to reset #TWs upon the following being true: #TWs is greater than or equal to a maximum number of time windows (max_TWs);
reset the #TWs upon a determination that #TWs is greater than or equal to max_TWs;
set, after resetting #TWs, the default for incrementing the donation percentage increase (d_incr) to a default value;
set, upon a determination that #TWs is not greater than or equal to max_TWs, the default for incrementing the donation percentage increase (d_incr) to a default value.

11. The system of claim 9, wherein the fav_sm is a favorable social media action comprising one or more social media posts, social media trends, or one or more reactions to one or more social media posts, and fav_sup is a favorable support comprising one or more responses from one or more donation transfer services.

12. The system of claim 9, wherein the d_incr is a default increase in donation percentage set by the processor.

13. The system of claim 9, wherein the num_trig is the number of transfers that trigger an increase in donation percentage

14. The system of claim 9, wherein the amt_trig is the cumulative amount trigger for increasing donation percentage

15. The system of claim 9, wherein the sm_trig is the trigger for the number of favorable social media posts leading to donation percentage increase, and the sup_trig is the trigger for the number of favorable support engagements leading to a donation percentage increase.

16. The system of claim 9, wherein the ms_trig is the trigger for the number of key customer milestones reached, leading to a donation percentage increase

17. The system of claim 10, wherein the max_TWs is the trigger for maximum number of time windows before a reset.

18. A method for selecting donations in dynamic lightweight personalized analytics (DLPA), the method comprising:
comparing, by the processor, the metrics for a predetermined time window;
calculating a new set of parameters for the donation metrics and KPIs;
determining whether to adjust the donation percentage by a predetermined amount upon any one of the following conditions being true: (1) a number of remittance transfers (# xfers) is greater than or equal to a trigger number (num_trig), (2) a cumulative transfer amount (cum_xfer) is greater than or equal to a trigger cumulative amount (amt_trig), (3) a number of favorable social media events is greater than or equal to a trigger number for favorable social media events (sm_trig), (4) a number of favorable support events (fav_sup) is greater than or equal to a trigger for the number of favorable support events (sup_trig), (5) a number of key customer milestones (kms) is greater than or equal to a trigger number for key customer milestones (ms_trig);
calculating, upon determining that any one of the conditions are true, whether current donation percentage increase (d_incr) is less than or equal to the maximum possible donation percentage (max_%);
incrementing, upon calculating that the donation percentage increase (d_incr) is greater than max_%, the d_incr value by an amount (incr_dn);
increasing, upon incrementing the donation percentage increase (d_incr) value, the percentage of the funds transfer fee by the incremented d_incr value;
transferring the donation percentage increase (d_incr) value of the funds to a predetermined charity; and
comparing, by the processor, the metrics for a new predetermined time window.

19. The method of claim 18, the method further comprising the steps of:
adjusting, upon determining that d_incr is less than or equal to max_%, the number of time windows (#TWs);
determining whether to reset #TWs upon the following being true: #TWs is greater than or equal to a maximum number of time windows (max_TWs);
resetting the #TWs upon a determination that #TWs is greater than or equal to the max_TWs;
setting, after resetting #TWs, the default for incrementing the donation percentage increase (d_incr) to a default value;
setting, upon a determination that #TWs is not greater than or equal to the max_TWs, the default for incrementing the donation percentage increase (d_incr) to a default value.

20. The method of claim 19, wherein the d_incr is a default increase in donation percentage set by the processor.
